(19) United States
(12) Patent Application Publication
(10) Pub. No.: US 2018/0303289 A1
(43) Pub. Date: Oct. 25, 2018

(54) PORTABLE ELECTRONIC GRINDER SYSTEM

(71) Applicant: Nicholas Varga, Vancouver (CA)

(72) Inventor: Nicholas Varga, Vancouver (CA)

(21) Appl. No.: 15/493,112

(22) Filed: Apr. 20, 2017

(51) Int. Cl. A47J 43/04; B02C 18/14; B02C 23/04

(52) U.S. Cl. CPC A47J 43/04; B02C 2018/168; B02C 23/04; B02C 18/14

(57) ABSTRACT

A portable electronic grinder system includes a portable electronic grinder having a first-chamber including at least one blade, and a motor, a second-chamber, a fastener, a power source, an activation button, a power-button, and a plurality of wires. The portable electronic grinder system provides a pocket-sized electronic herb grinding device for grinding at least one item.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of grinders and more specifically relates to a portable electronic grinder system.

### 2. Description of Related Art

A grinder is a mechanical device used for pulverizing herbs, spices, tobacco, and other dried plants into particulates. The herb grinded into the particulates is used in cooking or for other purposes. Typically, the grinders are operated either manually or electronically. The grinders operated electronically comprise a motor and a blade, both placed inside the grinder. Typically, the blade is screwed to the bottom of the grinder. In order to grind the herb, the herb is placed inside the grinder. When powered, the motor drives the blade, which, in turn grinds the herb. Current grinders do not provide portability and functionality. A suitable solution is desired.

U.S. Pat. No. 9,565,972 to Manuel Ormaza relates to an electric grinder having lighting means and a usb port for charging. The described electric grinder has lighting means and a usb port for charging includes grinder for grinding herbs, coffee beans, spices, tobacco, and other dried plants into particulates. The grinder comprises a body and a filter assembly. the filter assembly includes a mesh filter and is coupled at the bottom of the body. The body comprises a battery and blade coupled to a shaft, which, in turn is coupled to a motor. When the motor is run, the motor spins the blade, which, in turn grinds the herb into particulates. The particulates of herb are collected at a pollen catching cap after being filtered by the mesh filter. Further, the grinder can include a storage assembly to store or transport the particulates of the herb. The grinder can include a usb port to recharge the battery and a lighting means to provide visibility to a user operating the grinder.

### BRIEF SUMMARY OF THE INVENTION

In view of the foregoing disadvantages inherent in the known grinder art, the present disclosure provides a novel portable electronic grinder system. The general purpose of the present disclosure, which will be described subsequently in greater detail, is to provide a pocket-sized portable electronic herb grinder efficient for use.

A portable electronic grinder system is disclosed herein. The portable electronic grinder system includes a portable electronic grinder having a first-chamber including at least one blade, and a motor, a second-chamber, at least one fastener, a power source, an activation button, a power-button, and a plurality of wires. The portable electronic grinder system comprises the portable electronic grinder. The portable electronic grinder comprises the first-chamber, the second-chamber, the fastener, the power source, the activation button, the power-button, and a plurality of wires in functional combination.

The first-chamber houses the at least one blade and the motor. In a preferred embodiment, the first-chamber and the second-chamber comprise a cylindrical profile. The first-chamber overlaps the second-chamber for containing dust and resin located therewithin. The portable electronic grinder may further comprise an inner lip between the first-chamber and the second-chamber for effectively containing dust and resin within. The first-chamber and the second-chamber are configured to be connected via the fastener. The fastener comprises a magnetic element for securing the first-chamber and the second-chamber. In a preferred embodiment, both the first-chamber and the second-chamber are magnetized to hold the chambers together. The fastener comprises a male-member and a female-member. The first-chamber and the second-chamber each comprise one of the male-members and one the female-members, each set of the male-members and the female-members located on opposing sides.

The portable electronic grinder further comprises a sensor for sensing mating of the male-member and the female-member. The sensor must indicate the mating of the male-member and the female-member to operate the at least one blade and the motor. If the first-chamber and the second-chamber are not together the device will not operate. The top surface of the first-chamber comprises an activation button. The activation button, when manipulated by an operator, activates the at least one blade and the motor when the power-button is in an on position. The activation button is configured to be depressed to power-operate the at least one blade and the motor when the power-button is in the on position. A top surface of the first-chamber may comprise a light emitting diode indicator for indicating battery life and relative charging.

The second-chamber may include a micro USB input port for charging. The second-chamber preferably comprises a universal serial bus 2.0 output for charging external devices. The power source provides power to the portable electronic grinder initiating the at least one blade and the motor for grinding at least one item. At least one item may include marijuana, herbs or other items a user may wish to grind. The power source may comprise a rechargeable battery. In a preferred embodiment, the rechargeable battery is stored in the second-chamber.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable electronic grinder system, constructed and operative according to the teachings of the present disclosure.

FIG. 1 is a perspective view of the portable electronic grinder system during an ‘in-use’ condition, according to an embodiment of the disclosure.

FIG. 2 is a perspective view of the portable electronic grinder system of FIG. 1, according to an embodiment of the present disclosure.

FIG. 3 is an interior side view of the portable electronic grinder system of FIG. 1, according to an embodiment of the present disclosure.

FIG. 4 is a side view of the portable electronic grinder system of FIG. 1, according to an embodiment of the present disclosure.

FIG. 5 is a top view of the portable electronic grinder system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a grinder and more particularly to a portable electronic grinder system as used to improve the efficiency of grinding in remote locations.

Generally, the electronic motor drives cutting blades to grind herbs; the device being portable and easy to use. Safety may be achieved by having the rechargeable battery and motor on separate sides of the unit, so that the product will only work when both sides are attached. The device is a pocket sized electronic herb grinder which may be USB charged and include a plurality of blades. The present invention may include a USB charged battery and storage for herbs which may also provide a battery bank.

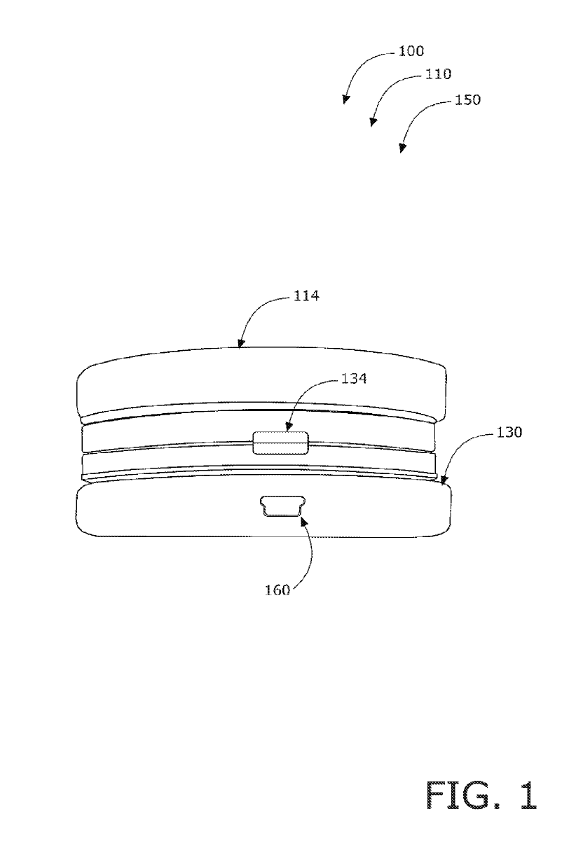

Referring now more specifically to the drawings by numerals of reference, there is shown in FIGS. 1-5, various views of a portable electronic grinder system 100. FIG. 1 shows a portable electronic grinder system 100 during an ‘in-use’ condition 150, according to an embodiment of the present disclosure. As illustrated, the portable electronic grinder system 100 may include a portable electronic grinder 110 having a first-chamber 114 including at least one blade 118, and a motor 122, a second-chamber 130, a fastener 134, a power source 136, an activation button 142, a power-button 146, and a plurality of wires 154. The portable electronic grinder system 100 comprises the portable electronic grinder 110. The portable electronic grinder 110 comprises the first-chamber 114, the second-chamber 130, the fastener 134, the power source 136, the activation button 142, the power-button 146, and a plurality of wires 154 in functional combination. The device provides a pocket-sized herb grinder for grinding items.

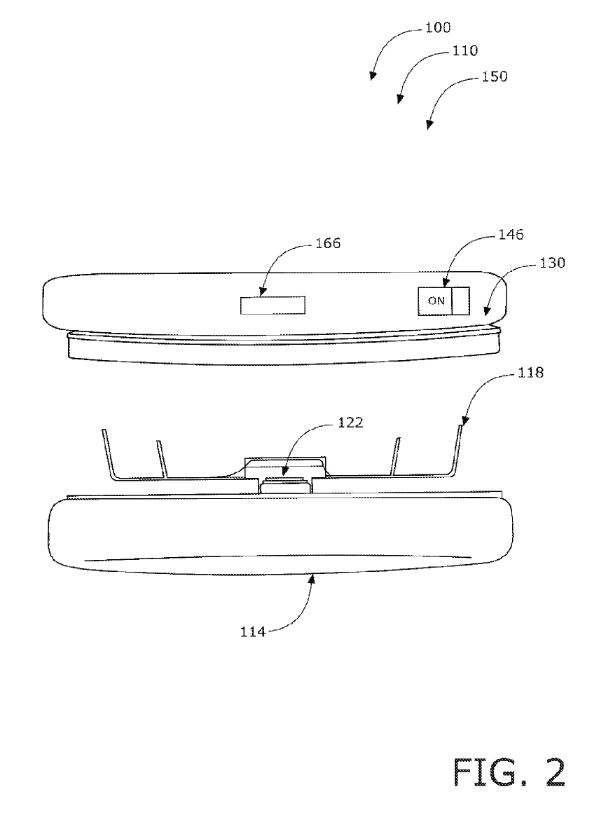

FIG. 2 shows a perspective view of the portable electronic grinder system 100 of FIG. 1, according to an embodiment of the present disclosure. As above, the portable electronic grinder system 100 may include a portable electronic grinder 110 having a first-chamber 114 including at least one blade 118, and a motor 122, a second-chamber 130, a fastener 134, a power source 136, an activation button 142, a power-button 146, and a plurality of wires 154. The first-chamber 114 houses at least one blade 118 and the motor 122. In a preferred embodiment, the first-chamber 114 and the second-chamber 130 comprise a cylindrical profile. The first-chamber 114 may overlap the second-chamber 130 for containing dust and resin located therewithin. The portable electronic grinder 110 may further comprise an inner lip between the first-chamber 114 and the second-chamber 130 for containing dust and resin within.

The first-chamber 114 and the second-chamber 130 are configured to be connected via the fastener 134. The fastener 134 may comprise a magnetic element for securing the first-chamber 114 and the second-chamber 130. The fastener 134 may include a magnetized ring or two magnetized connection points. Both the first-chamber 114 and the second-chamber 130 are held together by the fastener 134 which may be magnetized. The fastener 134 comprises a male-member 116 and a female-member 132. The first-chamber 114 and the second-chamber 130 each comprise one of the male-members 116 and one the female-members 132, each set of the male-members 116 and the female-members 132 located on opposing sides. For safety purposes, the device may not operate and initiate the motor 122 and at least one blade 118 without the first-chamber 114 and the second-chamber 130 being connected and secured. Other suitably equivalent fastening means may be used in alternate embodiments.

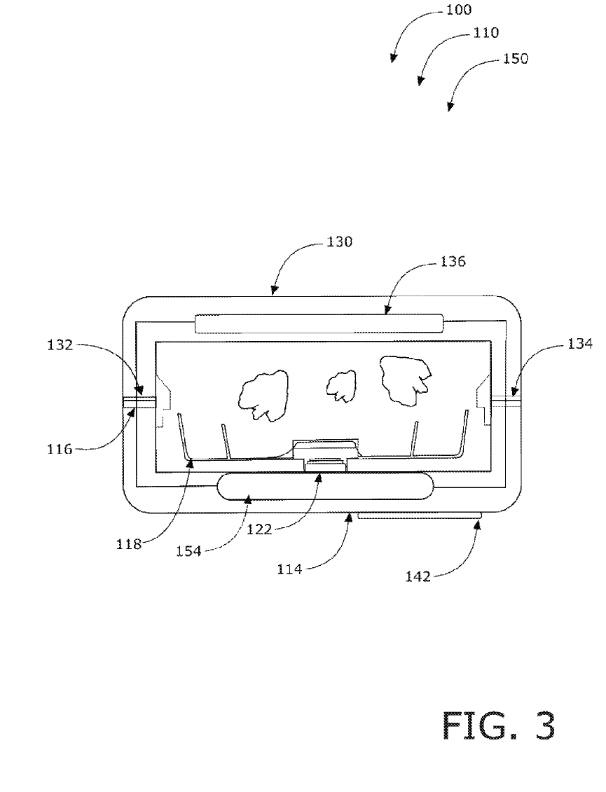

FIG. 3 shows an interior side view of the portable electronic grinder system 100 of FIG. 1, according to an embodiment of the present disclosure. As above, the portable electronic grinder system 100 may include the first-chamber 114 and the second-chamber 130. The portable electronic grinder 110 further comprises a sensor for sensing mating of the male-member 116 and the female-member 132. The sensor must indicate the mating of the male-member 116 and the female-member 132 to operate the at least one blade 118 and the motor 122. The top surface of the first-chamber 114 comprises an activation button 120. The activation button 120 when manipulated by an operator activates the at least one blade 118 and the motor 122 when the power-button 146 is in an on position and the first-chamber 114 and the second-chamber 130 are fastened. The activation button 120 is configured to be depressed to power-operate the at least one blade 118 and the motor 122 when the power-button 146 is in the on position.

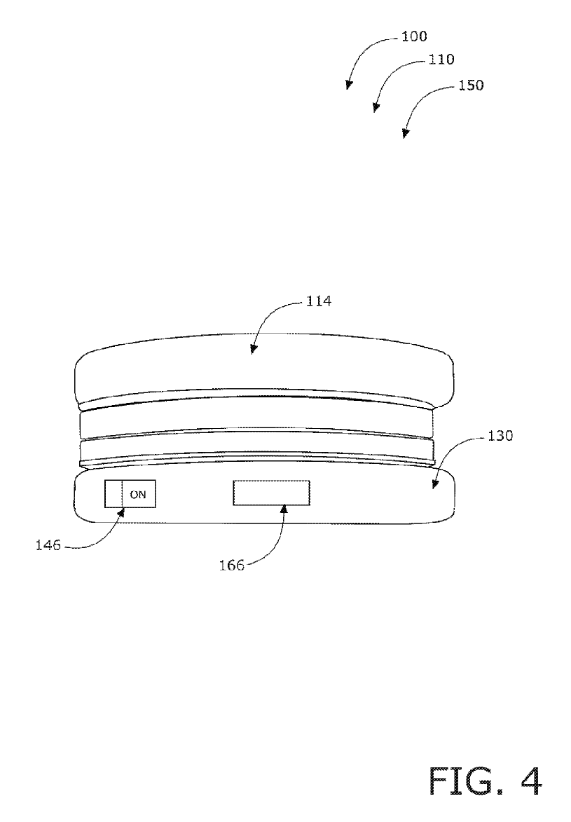

FIG. 4 shows a side view of the portable electronic grinder system 100 of FIG. 1, according to an embodiment of the present disclosure. As above, the portable electronic grinder system 100 may include the first-chamber 114 and the second-chamber 130. The second-chamber 130 may include a micro USB input port 160 for charging the device. In a preferred embodiment, the second-chamber 130 may comprise a USB 2.0 output for charging external devices for user convenience. The power source 136 provides power to the portable electronic grinder 110 initiating the at least one blade 118 and the motor 122 for grinding at least one item including marijuana or the like. The power source 136 may comprise a rechargeable battery or other suitable power source 136. The rechargeable battery may be stored in the second-chamber 130. A screen may also be included in the second-chamber 130 for catching resin.

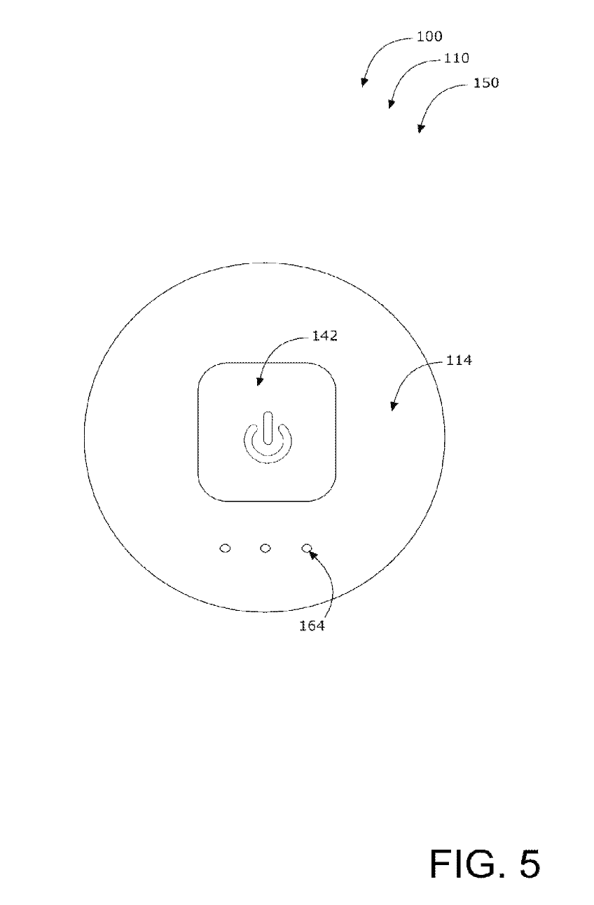

FIG. 5 shows a perspective view of the portable electronic grinder system 100 of FIG. 1, according to an embodiment of the present disclosure. As above, the portable electronic grinder system 100 may include a first-chamber 114 and a second-chamber 130. The first-chamber 114 and the second-chamber 130 comprise a non-stick material such as polytetrafluoroethylene, ceramic, aluminum or other suitable material to prevent buildup of resin within the device. A top surface of the first-chamber 114 may comprise a light emitting diode (LED) indicator 164 for indicating battery life and relative charging. The light emitting diode indicator 164 may include a tri-color indicator. Red may represent charging (input or output), yellow may indicate low battery, and green may indicate charged battery. The present invention may include a soft-touch material casing.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable electronic grinder system comprising:
a portable electronic grinder having;
a first-chamber including;
at least one blade; and
a motor;
a second-chamber;
a fastener;
a power source;
an activation button;
a power-button; and
a plurality of wires;
wherein said portable electronic grinder system comprises said portable electronic grinder;
wherein said portable electronic grinder comprises said first-chamber, said second-chamber, said fastener, said power source, said activation button, said power-button, and a plurality of wires in functional combination;
wherein said first-chamber houses said at least one blade and said motor;
wherein said first-chamber and said second-chamber are configured to be connected via said fastener;
wherein said top surface of said first-chamber comprises an activation button;
wherein said activation button when manipulated by an operator activates said at least one blade and said motor when said power-button is in an on position; and
wherein said power source provides power to said portable electronic grinder initiating said at least one blade and said motor for grinding at least one item.

2. The portable electronic grinder system of claim 1, wherein a top surface of said first-chamber comprises a light emitting diode indicator for indicating battery life and relative charging.

3. The portable electronic grinder system of claim 1, wherein said power source comprises a rechargeable battery.

4. The portable electronic grinder system of claim 3, wherein said rechargeable battery is stored in said second-chamber.

5. The portable electronic grinder system of claim 1, wherein said first-chamber and said second-chamber comprise a non-stick material selected from the group comprising polytetrafluoroethylene, ceramic, and aluminum.

6. The portable electronic grinder system of claim 1, wherein said fastener comprises a magnetic element for securing said first-chamber and said second-chamber.

7. The portable electronic grinder system of claim 6, wherein said fastener comprises a male-member and a female-member.

8. The portable electronic grinder system of claim 7, wherein said first-chamber and said second-chamber each comprise one of said male-members and one said female-members, each set of said male-members and said female-members located on opposing sides.

9. The portable electronic grinder system of claim 8, wherein said portable electronic grinder further comprises a sensor for sensing mating of said male-member and said female-member.

10. The portable electronic grinder system of claim 9, wherein said sensor must indicate said mating of said male-member and said female-member to operate said at least one blade and said motor.

11. The portable electronic grinder system of claim 1, wherein said activation button configured to be depressed to power-operate said at least one blade and said motor when said power-button is in said on position.

12. The portable electronic grinder system of claim 1, wherein said first-chamber and said second-chamber comprise a cylindrical profile.

13. The portable electronic grinder system of claim 1, wherein said second-chamber comprises a micro universal serial bus input port.

14. The portable electronic grinder system of claim 1, wherein said second-chamber comprises a universal serial bus 2.0 output for charging external devices.

15. The portable electronic grinder system of claim 1, wherein said first-chamber overlaps said second-chamber for containing dust and resin located therewithin.

16. The portable electronic grinder system of claim 1, wherein said portable electronic grinder further comprises an inner lip between said first-chamber and said second-chamber for containing dust and resin within.

17. A portable electronic grinder system comprising:
a portable electronic grinder having;
a first-chamber including;
at least one blade; and
a motor;
a second-chamber;
a fastener;
a power source;
an activation button;
a power-button; and
a plurality of wires;
wherein said portable electronic grinder system comprises said portable electronic grinder;
wherein said portable electronic grinder comprises said first-chamber, said second-chamber, said fastener, said power source, said activation button, said power-button, and a plurality of wires in functional combination;
wherein said first-chamber houses said at least one blade and said motor;
wherein said first-chamber and said second-chamber comprise a cylindrical profile;
wherein said first-chamber overlaps said second-chamber for containing dust and resin located therewithin;
wherein said portable electronic grinder further comprises an inner lip between said first-chamber and said second-chamber for containing dust and resin within;
wherein said first-chamber and said second-chamber are configured to be connected via said fastener;
wherein said fastener comprises a magnetic element for securing said first-chamber and said second-chamber;
wherein said fastener comprises a male-member and a female-member;
wherein said first-chamber and said second-chamber each comprise one of said male-members and one said female-members, each set of said male-members and said female-members located on opposing sides;
wherein said portable electronic grinder further comprises a sensor for sensing mating of said male-member and said female-member;
wherein said sensor must indicate said mating of said male-member and said female-member to operate said at least one blade and said motor;
wherein said top surface of said first-chamber comprises an activation button;
wherein said activation button when manipulated by an operator activates said at least one blade and said motor when said power-button is in an on position;
wherein said activation button configured to be depressed to power-operate said at least one blade and said motor when said power-button is in said on position;
wherein a top surface of said first-chamber comprises a light emitting diode indicator for indicating battery life and relative charging;
wherein said second-chamber comprises a micro universal serial bus input port;
wherein said second-chamber comprises a universal serial bus 2.0 output for charging external devices;
wherein said power source provides power to said portable electronic grinder initiating said at least one blade and said motor for grinding at least one item;
wherein said power source comprises a rechargeable battery; and
wherein said rechargeable battery is stored in said second-chamber.
